(19) United States
(12) Patent Application Publication
(10) Pub. No.: US 2019/0217405 A1
(43) Pub. Date: Jul. 18, 2019

(54) GEAR MACHINING APPARATUS AND GEAR MACHINING METHOD

(71) Applicant: JTEKT CORPORATION, Osaka-shi (JP)

(72) Inventor: Hideaki UNO, Nagoya-shi (JP)

(73) Assignee: JTEKT CORPORATION, Osaka-shi (JP)

(21) Appl. No.: 16/238,571

(22) Filed: Jan. 3, 2019

(30) Foreign Application Priority Data
Jan. 12, 2018 (JP) 2018-003336

(51) Int. Cl. B23F 1/06

(52) U.S. Cl. CPC B23F 1/06

(57) ABSTRACT

A gear machining apparatus includes a machining point setting unit that sets a machining point of a gear cutting tool to a position that is offset from a reference point. The gear cutting tool is arranged such that a projection line of a rotation axis of the gear cutting tool is parallel to a projection line of the rotation axis of the workpiece when viewed in a direction orthogonal to a reference plane, and intersects the projection line of the rotation axis of the workpiece when viewed in a direction orthogonal to a plane containing the rotation axis of the workpiece and the rotation axis of the gear cutting tool. The machining point setting unit sets an offset angle of the machining point from the reference point to different angles for roughing and for finishing.

### INCORPORATION BY REFERENCE

The disclosure of Japanese Patent Application No. 2018-003336 filed on Jan. 12, 2018 including the specification, drawings and abstract, is incorporated herein by reference in its entirety.

### BACKGROUND OF THE INVENTION

### 1. Field of the Invention

The present invention relates to a gear machining apparatus and a gear machining method.

### 2. Description of Related Art

There is a known technique for forming a gear on a workpiece by arranging the rotation axis of a gear cutting tool and the rotation axis of a workpiece in a skewed manner with respect to each other, and feeding the gear cutting tool with respect to the workpiece in the direction of the rotation axis of the workpiece while synchronously rotating the gear cutting tool and the workpiece.

Japanese Patent Application Publication No. 2015-006713 (JP 2015-006713 A) discloses a gear machining apparatus using the above technique. This gear machining apparatus forms a gear while securing a relief angle for machining, with use of a machining tool that includes cutting teeth having radially outer faces defining an external diameter that is constant in the extending direction of the cutting teeth.

According to the technique described in JP 2015-006713 A, the rake angle for machining increases in the negative direction as the relief angle increases. If the relief angle is not sufficiently large, the machined face of the workpiece is likely to be damaged due to interference with the flank, so that the surface properties of the machined face degrade. Meanwhile, if the rake angle increases in the negative direction, the cutting resistance during machining increases, so that the tool life is reduced.

### SUMMARY OF THE INVENTION

An object of the present invention is to provide a gear machining apparatus and a gear machining method that can extend the tool life while securing the surface properties of a machined face.

According to an aspect of the present invention, there is provided a gear machining apparatus that forms a gear on a workpiece by moving a gear cutting tool relative to the workpiece in a direction of a rotation axis of the workpiece while synchronously rotating the gear cutting tool and the workpiece, with a rotation axis of the gear cutting tool inclined with respect to a line parallel to the rotation axis of the workpiece, the gear cutting tool including a plurality of cutting teeth having outer peripheral faces of which imaginary circumscribed surface is cylindrical.

A plane containing the rotation axis of the workpiece and a predetermined reference point on the outer peripheral face of the workpiece is defined as a reference plane. The gear machining apparatus includes a machining point setting unit that sets a machining point of the gear cutting tool when viewed in the direction of the rotation axis of the workpiece to a position that is offset from the reference point when viewed in the direction of the rotation axis of the workpiece. The gear cutting tool is arranged such that a projection line of the rotation axis of the gear cutting tool is parallel to a projection line of the rotation axis of the workpiece when viewed in a direction orthogonal to the reference plane, and intersects the projection line of the rotation axis of the workpiece when viewed in a direction orthogonal to a plane containing the rotation axis of the workpiece and the rotation axis of the gear cutting tool. The machining point setting unit sets an offset angle of the machining point from the reference point when viewed in a direction of the rotation axis of the workpiece to different angles for roughing and for finishing.

According to the gear machining apparatus of the above aspect, the machining point setting unit sets the offset angle of the machining point from the reference point when viewed in the direction of the rotation axis of the workpiece to different angles for roughing and for finishing. Thus, the machining point setting unit can set the machining point to such a position that interference between the gear cutting tool and the workpiece is more easily reduced than in the finishing process, or such a position that the cutting resistance is reduced, in the roughing process, while forming a gear having a desired shape on the workpiece in the finishing process. Accordingly, the gear machining apparatus can extend the life of the gear cutting tool while securing the surface properties of the machined face of the workpiece.

According to another aspect of the present invention, there is provided a gear machining method that forms a gear on a workpiece by moving a gear cutting tool relative to the workpiece in a direction of a rotation axis of the workpiece while synchronously rotating the gear cutting tool and the workpiece, with a rotation axis of the gear cutting tool inclined with respect to a line parallel to the rotation axis of the workpiece, the gear cutting tool including a plurality of cutting teeth having outer peripheral faces of which imaginary circumscribed surface is cylindrical.

A plane containing the rotation axis of the workpiece and a predetermined reference point on the outer peripheral face of the workpiece is defined as a reference plane. The gear machining method includes: a roughing step of setting a machining point of the gear cutting tool when viewed in the direction of the rotation axis of the workpiece to a position that is offset from the reference point when viewed in the direction of the rotation axis of the workpiece, and performing roughing of the workpiece with the gear cutting tool; and a finishing step of setting the machining point to a position that is offset from the reference point when viewed in the direction of the rotation axis of the workpiece and that is different from the machining point in the roughing step, and performing finishing of the workpiece with the gear cutting tool.

According to the gear machining method of the above aspect, the machining point is set to different positions for the roughing step and for the finishing step. Thus, the gear machining method can set the machining point to such a position that interference between the gear cutting tool and the workpiece is more easily reduced than in the finishing step, or such a position that the cutting resistance is reduced, in the roughing step, while forming a gear having a desired shape on the workpiece in the finishing step. Accordingly, the gear machining method can extend the life of the gear cutting tool while securing the surface properties of the machined face of the workpiece.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view illustrating a gear machining apparatus according to an embodiment of the present invention;

FIG. 2 is a partially enlarged cross-sectional view illustrating a gear cutting tool;

FIG. 3 illustrates a rake angle and a relief angle formed during machining of a workpiece with a cutting tooth;

FIG. 4 is a block diagram illustrating a control device;

FIG. 5A schematically illustrates the positional relationship between the gear cutting tool and the workpiece during finishing as viewed in a rotation axis direction of the workpiece;

FIG. 5B schematically illustrates the positional relationship between the gear cutting tool and the workpiece during finishing as viewed in a direction VB indicated in FIG. 5A;

FIG. 5C schematically illustrates the positional relationship between the gear cutting tool and the workpiece during finishing as viewed in a direction VC indicated in FIG. 5A;

FIG. 6 is a graph representing the relationship among an offset angle, a rake angle, and a relief angle;

FIG. 7 schematically illustrates the positional relationship between the gear cutting tool and the workpiece during roughing as viewed in the rotation axis direction of the workpiece;

FIG. 8 schematically illustrates cutting allowances that are cut with the gear cutting tool in a roughing process and a finishing process;

FIG. 9 is a flowchart illustrating a gear machining process performed by the control device;

FIG. 10 schematically illustrates the positional relationship between the gear cutting tool and the workpiece during first roughing and second roughing as viewed in the rotation axis direction of the workpiece according to a modification;

FIG. 11 schematically illustrates cutting allowances that are cut with the gear cutting tool in a first roughing process, a second roughing process, and a finishing process; and

FIG. 12 is a flowchart illustrating a gear machining process 2 performed by the control device.

### DETAILED DESCRIPTION OF EMBODIMENTS

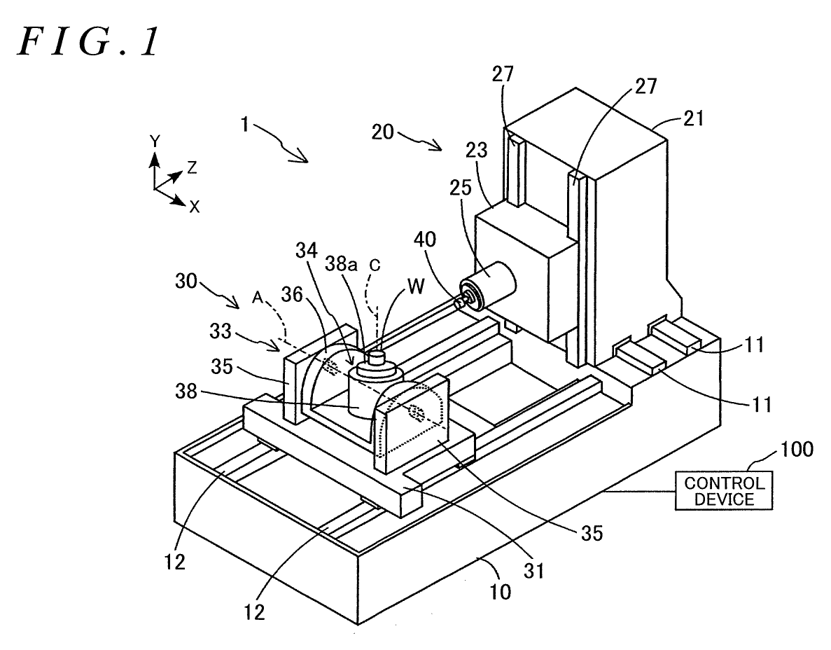

Hereinafter, embodiments to which a gear machining apparatus and a gear machining method according to the present invention are applied will be described with reference to the drawings. First, an overview of a gear machining apparatus 1 in an embodiment of the present invention will be described with reference to FIG. 1.

As illustrated in FIG. 1, the gear machining apparatus 1 is a machining center having, as drive axes, three rectilinear axes (X-, Y-, and Z-axes) orthogonal to each other, and two rotation axes (A- and C-axes). The gear machining apparatus 1 includes a bed 10, a tool holding device 20, a workpiece holding device 30, and a control device 100.

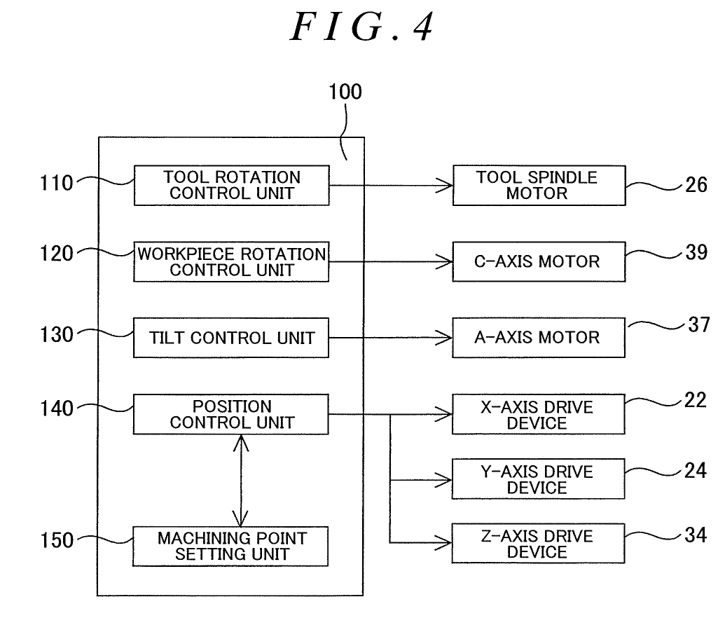

The bed 10 is disposed on the floor. A pair of X-axis guide rails 11 extending in the X-axis direction and a pair of Z-axis guide rails 12 extending in the Z-axis direction are disposed on the upper surface of the bed 10. The tool holding device 20 includes a column 21, an X-axis drive device 22 (see FIG. 4), a saddle 23, a Y-axis drive device 24 (see FIG. 4), a tool spindle 25, and a tool spindle motor 26 (see FIG. 4). Note that the X-axis drive device 22, the Y-axis drive device 24, and the tool spindle motor 26 are not illustrated in FIG. 1.

The column 21 is movable along the pair of X-axis guide rails 11 in the X-axis direction. The X-axis drive device 22 is a feed screw device that feeds the column 21 in the X-axis direction with respect to the bed 10. A pair of Y-axis guide rails 27 extending in the Y-axis direction are disposed on the side surface of the column 21. The saddle 23 is movable with respect to the column 21, along the pair of Y-axis guide rails 27 in the Y-axis direction. The Y-axis drive device 24 is a feed screw device that feeds the saddle 23 in the Y-axis direction.

The tool spindle 25 is supported on the saddle 23 so as to be rotatable about an axis parallel to the Z-axis. A gear cutting tool 40 used for machining a workpiece W is removably attached to the distal end of the tool spindle 25. The gear cutting tool 40 moves in the X-axis direction with the movement of the column 21, and moves in the Y-axis direction with the movement of the saddle 23. The tool spindle motor 26 applies a drive force for rotating the tool spindle 25, and is accommodated in the saddle 23.

The workpiece holding device 30 includes a slide 31, a Z-axis drive device 32 (see FIG. 4), a tilt device 33, and a workpiece rotating device 34. Note that the Z-axis drive device 32 is not illustrated in FIG. 1. The slide 31 is movable with respect to the bed 10, along the pair of Z-axis guide rails 12 in the Z-axis direction. The Z-axis drive device 32 is a feed screw device that feeds the slide 31 in the Z-axis direction.

The tilt device 33 includes a pair of table support portions 35, a tilt table 36, and an A-axis motor 37 (see FIG. 4). The pair of table support portions 35 are disposed on the upper surface of the slide 31. The tilt table 36 is supported by the pair of table support portions 35 so as to be turnable about the A-axis parallel to the X-axis. The A-axis motor 37 is a motor that applies a drive force for turning the tilt table 36, and is accommodated in the table support portions 35.

The workpiece rotating device 34 includes a turntable 38 and a C-axis motor 39 (see FIG. 4). The turntable 38 is disposed on the bottom surface of the tilt table 36 so as to be rotatable about the C-axis orthogonal to the A-axis. The turntable 38 is provided with a holder 38a for fixing the workpiece W. The C-axis motor 39 applies a drive force for rotating the turntable 38, and is disposed on the lower surface of the tilt table 36.

When performing gear machining, the gear machining apparatus 1 turns the tilt table 36, thereby inclining the rotation axis of the gear cutting tool 40 with respect to a line parallel to the rotation axis of the workpiece W. Then, the gear machining apparatus 1 synchronously rotates the gear cutting tool 40 and the workpiece W, and performs cutting while feeding the gear cutting tool 40 in the rotation axis direction of the workpiece W.

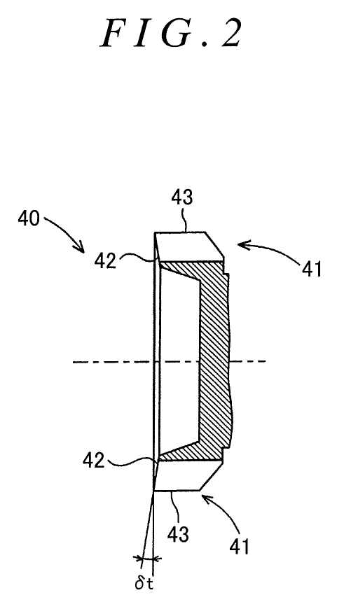

In the following, the gear cutting tool 40 will be described with reference to FIG. 2. As illustrated in FIG. 2, the gear cutting tool 40 includes a plurality of cutting teeth 41. Each of the cutting teeth 41 includes a rake face 42 having a tool rake angle δt, on its end face thereof facing the distal end side (left side in FIG. 2) of the gear cutting tool 40. Outer peripheral faces 43 of the plurality of cutting teeth 41 define a constant external diameter in the rotation axis direction of the gear cutting tool 40, so that an imaginary circumscribed surface of the outer peripheral faces 43 of the plurality of cutting teeth 41 is cylindrical. In this gear cutting tool 40, compared to the case where the outer peripheral faces are formed in a conical shape, it is possible to minimize a change in the shape of the cutting teeth 41 due to regrinding. That is, in the gear cutting tool 40, compared to the case where the outer peripheral faces 43 has a tool relief angle, the cutting teeth 41 can be accurately formed in the desired shape even if the regrinding is performed more often. As a result, the life of the gear cutting tool 40 can be extended.

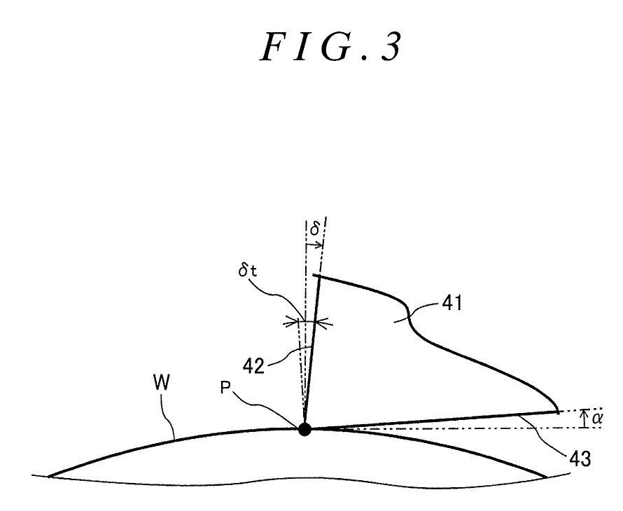

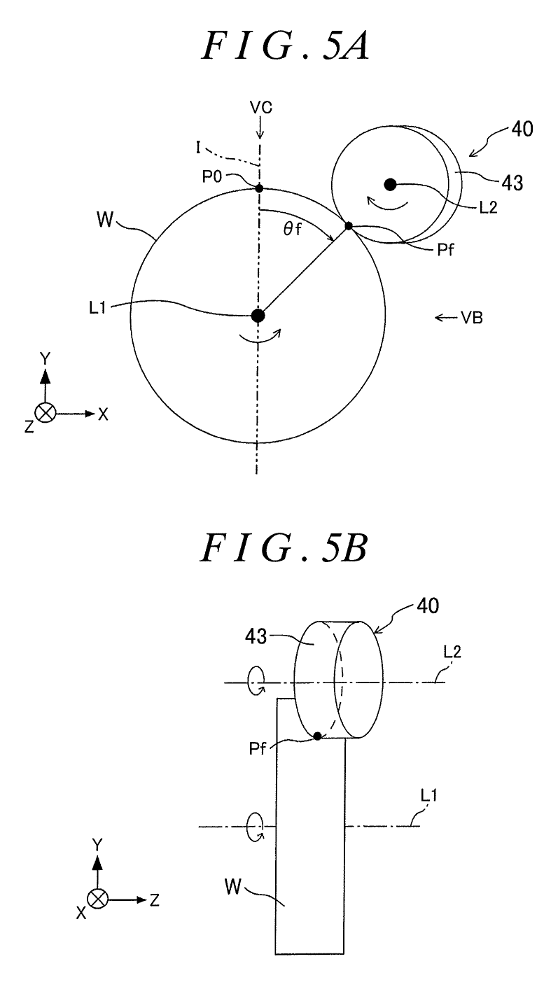

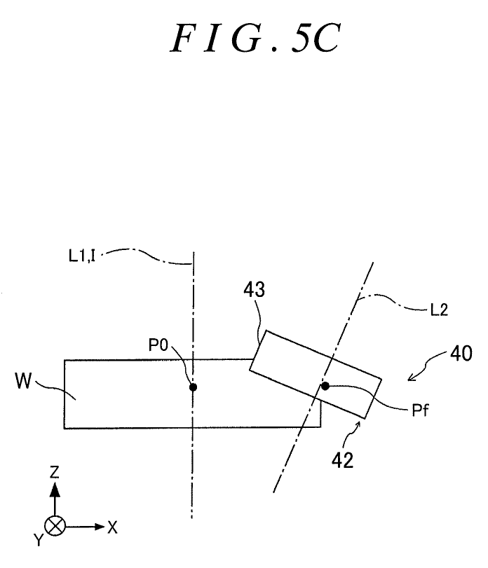

As illustrated in FIG. 3, the gear machining apparatus 1 sets a machining point P where the cutting tooth 41 and the workpiece W contact each other during gear machining to a position such that a relief angle α between the outer peripheral face 43 of the cutting tooth 41 and the workpiece W is greater than a predetermined angle. Thus, even when gear machining is performed using the gear cutting tool 40, the gear machining apparatus 1 can form a relief angle for gear machining. As a result, the gear machining apparatus 1 can reduce interference between the workpiece W and the cutting teeth 41 during machining, and improve the surface properties of the machined face. The positional relationship between the gear cutting tool 40 and the workpiece W during gear machining will be described below with reference to FIGS. 5A to 5C.

In the following, the control device 100 will be described with reference to FIG. 4. As illustrated in FIG. 4, the control device 100 includes a tool rotation control unit 110, a workpiece rotation control unit 120, a tilt control unit 130, a position control unit 140, and a machining point setting unit 150. The tool rotation control unit 110 controls driving of the tool spindle motor 26 to rotate the gear cutting tool 40 attached to the tool spindle 25. The workpiece rotation control unit 120 controls driving of the C-axis motor 39 to rotate the workpiece W fixed to the turntable 38 about the rotation axis (about the C-axis). The tilt control unit 130 controls driving of the A-axis motor 37 to turn the tilt table 36, and thereby to turn the workpiece W fixed to the turntable 38 about the A-axis.

The position control unit 140 controls driving of the X-axis drive device 22 to move the column 21 in the X-axis direction, and controls driving of the Y-axis drive device 24 to move the saddle 23 in the Y-axis direction. Thus, the gear cutting tool 40 held by the tool holding device 20 moves relative to the workpiece W held by the workpiece holding device 30 in the X-axis direction and the Y-axis direction. The position control unit 140 controls driving of the Z-axis drive device 32 to move the slide 31 in the Z-axis direction. Thus, the workpiece W held by the workpiece holding device 30 moves relative to the gear cutting tool 40 held by the tool holding device 20 in the Z-axis direction.

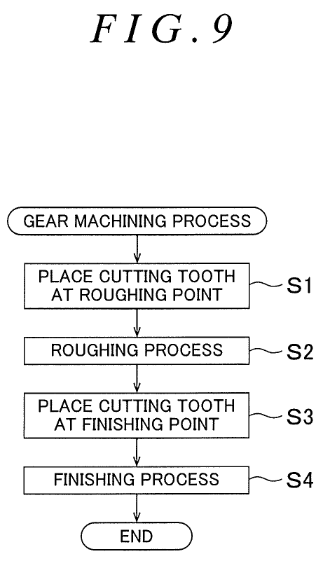

The machining point setting unit 150 sets the machining point P for performing gear cutting on the workpiece W. More specifically, the gear machining apparatus 1 performs a roughing process and a finishing process, as a gear machining process of performing gear machining on the workpiece W (see FIG. 9). Thus, the machining point setting unit 150 sets a roughing point Pr, which is a machining point in a roughing process, to a position different from the position of a finishing point Pf, which is a machining point in a finishing process.

In the following, the positional relationship of the gear cutting tool 40 with the workpiece W, specifically, the positional relationship in a finishing process, will be described with reference to FIGS. 5A to 5C. In the present embodiment, an external gear is formed on the workpiece W. Further, in the following description, an imaginary plane (YZ plane) containing a rotation axis L1 of the workpiece W and a predetermined reference point P0 on the outer peripheral face of the workpiece W is defined as a reference plane I. The position P0 is a machining point where the relief angle is zero degree.

As illustrated in FIG. 5A, when viewed in the direction of the rotation axis L1 of the workpiece W (Z-axis direction), the finishing point Pf of the gear cutting tool 40 on the workpiece W is set to a position that is offset from the reference point P0. In other words, the finishing point Pf is set to a position that is phase-shifted from the reference point P0 by a predetermined angle (offset angle θf) about the rotation axis L1 of the workpiece W.

Further, as illustrated in FIG. 5B, when viewed in the direction (X-axis direction) orthogonal to the reference plane I, the workpiece W and the gear cutting tool 40 are arranged such that the projection line of the rotation axis L1 of the workpiece W and the projection line of a rotation axis L2 of the gear cutting tool 40 are parallel to each other.

Further, as illustrated in FIG. 5C, when viewed in the direction (Y-axis direction) orthogonal to a plane (ZX plane) containing the rotation axis L1 of the workpiece W and the rotation axis L2 of the gear cutting tool 40, the workpiece W and the gear cutting tool 40 are arranged such that the projection line of the rotation axis L1 of the workpiece W and the projection line of the rotation axis L2 of the gear cutting tool 40 intersect each other on the side that the rake face 42 of the gear cutting tool 40 faces.

The control device 100 feeds the gear cutting tool 40 with respect to the workpiece W in the direction of the rotation axis L1 of the workpiece W, while synchronously rotating the workpiece W and the gear cutting tool 40 that are arranged in the positional relationship illustrated in FIGS. 5A to 5C.

By arranging the workpiece W and the gear cutting tool 40 in the positional relationship illustrated in FIGS. 5A to 5C, the gear machining apparatus 1 can form a relief angle αf between the outer peripheral face of the gear cutting tool 40 and the outer peripheral face of the workpiece W at the finishing point Pf. Thus, since the gear machining apparatus 1 can form the relief angle αf without providing a drive shaft for forming the relief angle αf, the structure of the gear machining apparatus 1 can be simplified.

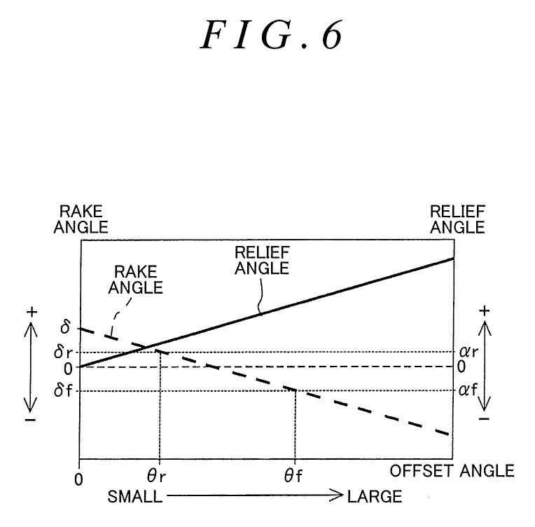

As illustrated in the graph of FIG. 6, in the gear machining apparatus 1, as an offset angle θ is increased, the relief angle α can be increased. Thus, the interference between the workpiece W and the gear cutting tool 40 can be easily avoided, and therefore the gear machining apparatus 1 can secure the surface properties of the machined face. Meanwhile, as the offset angle θ is increased, the rake angle δ increases in the negative direction. As the rake angle δ increases in the negative direction, the cutting resistance during machining increases, so that the gear cutting tool 40 is likely to wear quickly. Further, as the cutting resistance increases, the machining efficiency decreases, so that the time required for gear machining increases.

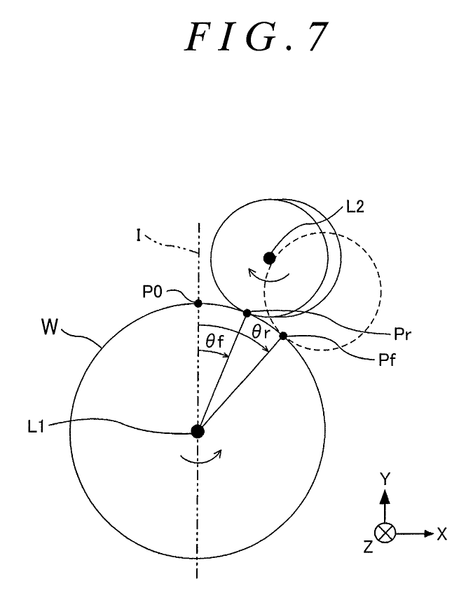

In view of the above, as illustrated in FIG. 7, the machining point setting unit 150 sets an offset angle θr for the roughing process to an angle less than the offset angle θf for the finishing process. In this case, as illustrated in FIG. 6, the gear machining apparatus 1 can make a rake angle δr for machining at the roughing point Pr greater than a rake angle δf for machining at the finishing point Pf. In particular, when the rake angle δf for machining at the finishing point Pf is negative, the machining point setting unit 150 sets the roughing point Pr to such a position that the rake angle δf is positive.

Accordingly, the gear machining apparatus 1 can reduce the cutting resistance during roughing, and thus can smoothly perform cutting during roughing, which reduces the time required for the roughing process. Further, when the machining point setting unit 150 sets the roughing point Pr to such a position that the relief angle αr is sufficiently large, the interference between the outer peripheral face 43 of the cutting tooth 41 and the machined face of the workpiece W can be easily avoided.

The cutting tooth 41 (see FIG. 2) of the gear cutting tool 40 is formed in a shape designed to perform machining at the finishing point Pf. That is, when the machining point P is set to the finishing point Pf, the gear machining apparatus 1 can form a gear having the desired shape on the workpiece W. Accordingly, if the machining point P is set to the roughing point Pr, the gear machining apparatus 1 cannot form a gear having the desired shape on the workpiece W.

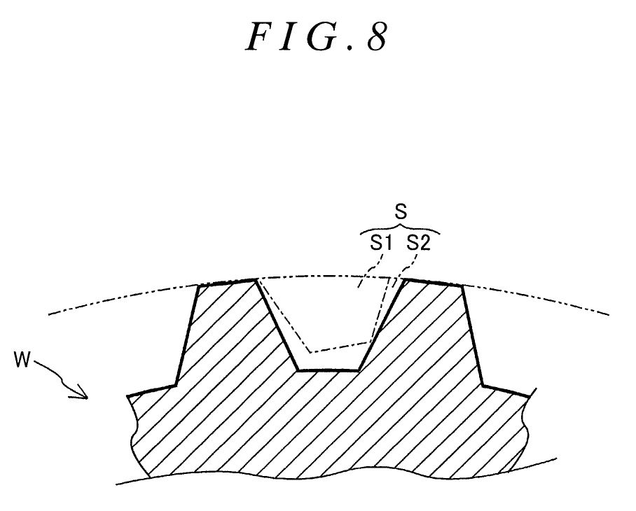

In view of the above, as illustrated in FIG. 8, the gear machining apparatus 1 cuts a cutting allowance S1 in the roughing process. The cutting allowance S1 is a part of a cutting allowance S that is cut in the gear machining process. That is, in the roughing process, gear machining is performed with the gear cutting tool 40 such that a cutting allowance S2 remains. Then, the gear machining apparatus 1 cuts the cutting allowance S2 remaining after the roughing process, and thereby forms a gear having the desired shape on the workpiece W.

Compared to the case of forming an internal gear on the workpiece W, when the gear machining apparatus 1 forms an external gear on the workpiece W, interference between the workpiece W and the gear cutting tool 40 is easily avoided, which allows more freedom in setting the roughing point Pr and the finishing point Pf.

As described above, the machining point setting unit 150 sets the offset angle θ of the machining point P from the reference point P0 when viewed in the direction of the rotation axis L1 of the workpiece W to different angles for roughing and for finishing. The machining point setting unit 150 sets the offset angle θr for roughing to an angle less than the offset angle θf for finishing. Thus, the machining point setting unit 150 can set the roughing point Pr to such a position that interference between the gear cutting tool 40 and the workpiece W is more easily avoided in the roughing process than in the finishing process, while forming a gear having a desired shape on the workpiece W in the finishing process. Accordingly, the gear machining apparatus 1 can extend the life of the gear cutting tool 40 while securing the surface properties of the machined face of the workpiece W.

In the following, a gear machining process performed by the control device 100 will be described with reference to the flowchart of FIG. 9. As illustrated in FIG. 9, in the gear machining process, the gear cutting tool 40 is first moved such that the cutting tooth 41 is placed at the roughing point Pr (S1). After step S1, a roughing process is performed (S2). For cutting the cutting allowance S1 illustrated in FIG. 8 in the roughing process, the gear machining apparatus 1 may perform a machining operation multiple times, and the cutting allowance that is cut in each machining operation may be reduced.

After step S2, the gear cutting tool 40 is moved such that the cutting tooth 41 is placed at the finishing point Pf (S3). After step S3, the finishing process is performed (S4). Thus, the gear machining process ends. As in the roughing process, for cutting the cutting allowance S2 illustrated in FIG. 8 in the finishing process, the gear machining apparatus 1 may perform a machining operation multiple times, and the cutting allowance that is cut in each machining operation may be reduced.

In this manner, the gear machining process includes: a roughing step of setting the roughing point Pr to a position that is offset from the reference point P0 when viewed in the direction of the rotation axis L1 of the workpiece W, and performing roughing of the workpiece W with the gear cutting tool 40; and a finishing step of setting the finishing point Pf to a position that is offset from the reference point P0 and that is different from the roughing point Pr. Thus, the gear machining apparatus 1 can set the roughing point Pr to such a position that the cutting resistance is reduced in the roughing process, while forming a gear having a desired shape on the workpiece W in the finishing step. Accordingly, the gear machining apparatus 1 can extend the life of the gear cutting tool 40 while securing the surface properties of the machined face of the workpiece W.

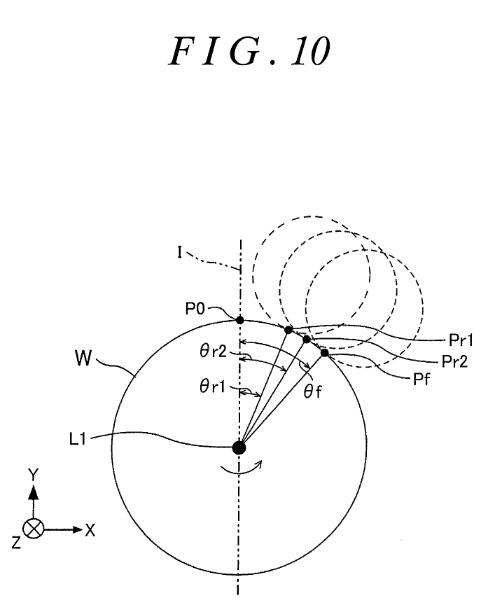

In the following, a modification of the gear machining process described above will be described with reference to FIGS. 10 to 12. In the above embodiment, the machining point setting unit 150 sets two machining points P, which are the roughing point Pr and the finishing point Pf. However, the present invention is not limited thereto, and three or more machining points P may be set. For example, the gear machining process may include a roughing process in which roughing is performed multiple times such that the machining point setting unit 150 gradually changes the offset angle θr for roughing such that the offset angle θr approaches the offset angle for finishing. In the following, a gear machining process 2 will be described as an example of this gear machining process. In the gear machining process 2, a roughing process includes a first roughing process in which roughing is performed at a first roughing position Pr1, and a second roughing process in which roughing is performed at a second roughing position Pr2.

As illustrated in FIG. 10, in the gear machining process 2, the gear machining apparatus 1 sets an offset angle θr2 for the second roughing process to an angle greater than an offset angle θr1 for the first roughing process such that the offset angle θr2 approaches the offset angle θf for the finishing process, when viewed in the direction of the rotation axis L1 of the workpiece W (Z-axis direction). As a result, the second roughing point Pr2 is located closer to the finishing point Pf than the first roughing point Pr1 is.

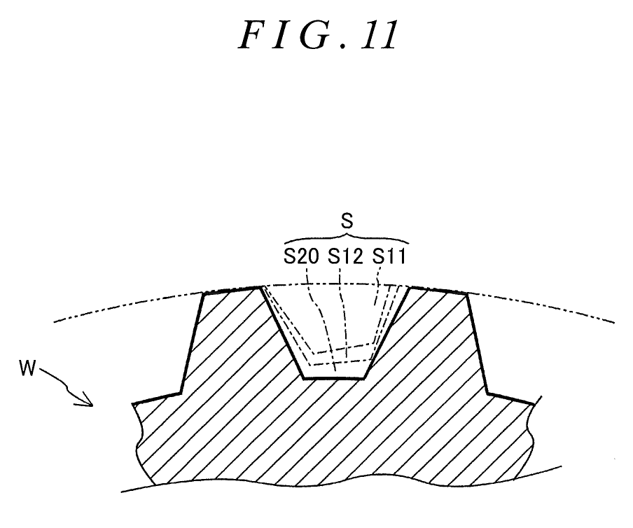

In this case, as illustrated in FIG. 11, compared to the case where the finishing process is performed after the first roughing process, the gear machining apparatus 1 can reduce a cutting allowance S20 remaining after the second roughing process, that is, the cutting allowance S20 that is cut in the finishing process, by the size of a cutting allowance S12 that is cut in the second roughing process. Accordingly, the gear machining apparatus 1 can reduce the cutting load applied to the gear cutting tool 40 in the finishing process.

Further, since the rake angle δ can be increased in the positive direction in the first roughing process compared to the second roughing process, the cutting resistance during roughing can be reduced. Therefore, compared to the case where the second roughing process is directly performed without performing the first roughing process, the gear machining apparatus 1 can reduce the cutting load applied to the gear cutting tool 40 in the whole roughing process including the first roughing process and the second roughing process. As a result, the gear machining apparatus 1 can extend the life of the gear cutting tool 40. Further, since the cutting allowance S11 that is cut in the first roughing process is reduced, the gear machining apparatus 1 can reduce accidental cutting of a portion other than the cutting allowance S in the first roughing process.

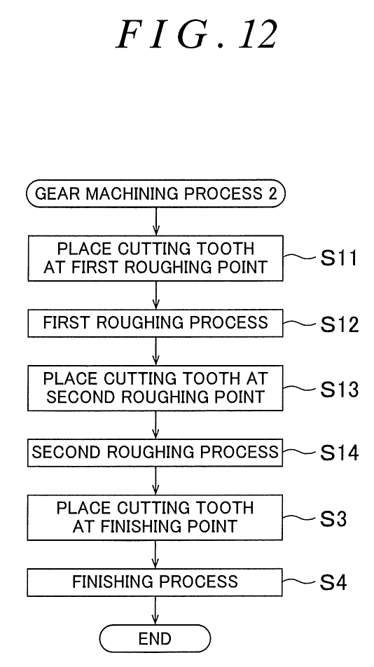

In the following, a gear machining process 2 performed by the control device 100 will be described with reference to the flowchart of FIG. 12. As illustrated in FIG. 12, in the gear machining process 2, the gear cutting tool 40 is first moved such that the cutting tooth 41 is placed at the roughing point Pr1 (S11). After step S11, the first roughing process is performed (S12).

After step S12, the gear cutting tool 40 is moved such that the cutting tooth 41 is placed at the second finishing point Pr2 (S13). After step S13, the second roughing process is performed (S14).

After step S14, the gear cutting tool 40 is moved such that the cutting tooth 41 is placed at the finishing point Pf (S3). After step S3, the finishing process is performed (S4). Thus, the gear machining process 2 ends. In each of the first roughing process, the second roughing process, and the finishing process, the gear machining apparatus 1 may perform a machining operation multiple times, and the cutting allowance that is cut in each machining operation may be reduced.

In gear skiving, the rotation axis of a skiving cutter serving as a gear cutting tool and the rotation axis of the workpiece W are neither perpendicular nor parallel to each other when viewed in the direction orthogonal to a plane containing a machining point with which the gear cutting tool is in contact and the rotation axis of the workpiece W. That is, gear skiving enables efficient gear machining by arranging the rotation axis of the skiving cutter and the rotation axis of the workpiece W in a skewed manner with respect to each other, and synchronously rotating the skiving cutter and the workpiece W. Moreover, the skiving cutter has a front relief angle and a side relief angle, and therefore its shape is easily changed when subjected to regrinding. Accordingly, the allowable amount of regrinding is limited.

Meanwhile, the gear cutting tool 40 has a cylindrical shape, and therefore its shape is easily maintained even when subjected to regrinding. Accordingly, the allowable amount of regrinding can be increased compared to the skiving cutter. Moreover, the gear cutting tool 40 has a higher rigidity than the skiving cutter, and thus, it is possible to suppress early damage of the gear cutting tool 40.

Since the gear cutting tool 40 has a cylindrical shape, the rake angle may be negative depending on the magnitude of the offset angle. When the rake angle is negative, the cutting resistance is increased, which results in reduced machining efficiency and shorter tool life. In view of this, the gear machining method performed by the gear machining apparatus 1 can reduce the cutting resistance by specifying the offset angle, and thus can optimize gear machining. This makes it possible to improve the machining efficiency, and extend the tool life.

In the above embodiments, the machining point setting unit 150 sets the offset angle θr for the roughing process to an angle less than the offset angle θf for the finishing process. However, the present invention is not limited thereto. That is, when setting the offset angle θ to different angles for rouging and for finishing, the machining point setting unit 150 may set the offset angle θr for the roughing process to an angle greater than the offset angle θf for the finishing process. In this case, the gear machining apparatus 1 can set the roughing point Pr to such a position that the relief angle α for roughing is greater than the relief angle for finishing, that is, such a position that interference between the gear cutting tool 40 and the workpiece W is more easily reduced during roughing than during finishing.

In the above embodiments, the present invention is applied to the case of forming an external gear on the workpiece W. However, the present invention may also be applied to the case of forming an internal gear on the workpiece W.

What is claimed is:

1. A gear machining apparatus that forms a gear on a workpiece by moving a gear cutting tool relative to the workpiece in a direction of a rotation axis of the workpiece while synchronously rotating the gear cutting tool and the workpiece, with a rotation axis of the gear cutting tool inclined with respect to a line parallel to the rotation axis of the workpiece, the gear cutting tool including a plurality of cutting teeth having outer peripheral faces of which imaginary circumscribed surface is cylindrical,
a plane containing the rotation axis of the workpiece and a predetermined reference point on an outer peripheral face of the workpiece being defined as a reference plane, the gear machining apparatus comprising:
a machining point setting unit that sets a machining point of the gear cutting tool when viewed in the direction of the rotation axis of the workpiece to a position that is offset from the reference point when viewed in the direction of the rotation axis of the workpiece; wherein
the gear cutting tool is arranged such that a projection line of the rotation axis of the gear cutting tool is parallel to a projection line of the rotation axis of the workpiece when viewed in a direction orthogonal to the reference plane, and intersects the projection line of the rotation axis of the workpiece when viewed in a direction orthogonal to a plane containing the rotation axis of the workpiece and the rotation axis of the gear cutting tool; and
the machining point setting unit sets an offset angle of the machining point from the reference point when viewed in a direction of the rotation axis of the workpiece to different angles for roughing and for finishing.

2. The gear machining apparatus according to claim 1, wherein the machining point setting unit sets the offset angle for roughing to an angle less than the offset angle for finishing.

3. The gear machining apparatus according to claim 2, wherein
the gear machining apparatus performs roughing multiple times; and
the machining point setting unit gradually changes the offset angle for roughing such that the offset angle for roughing approaches the offset angle for finishing.

4. The gear machining apparatus according to claim 1, wherein the gear machining apparatus forms an external gear on the workpiece.

5. A gear machining method that forms a gear on a workpiece by moving a gear cutting tool relative to the workpiece in a direction of a rotation axis of the workpiece while synchronously rotating the gear cutting tool and the workpiece, with a rotation axis of the gear cutting tool inclined with respect to a line parallel to the rotation axis of the workpiece, the gear cutting tool including a plurality of cutting teeth having outer peripheral faces of which imaginary circumscribed surface is cylindrical,
a plane containing the rotation axis of the workpiece and a predetermined reference point on an outer peripheral face of the workpiece being defined as a reference plane, the gear machining method comprising:
a roughing step of setting a machining point of the gear cutting tool when viewed in the direction of the rotation axis of the workpiece to a position that is offset from the reference point when viewed in the direction of the rotation axis of the workpiece, and performing roughing of the workpiece with the gear cutting tool; and
a finishing step of setting the machining point to a position that is offset from the reference point when viewed in the direction of the rotation axis of the workpiece and that is different from the machining point in the roughing step, and performing finishing of the workpiece with the gear cutting tool.
